(19) United States
(12) Patent Application Publication
(10) Pub. No.: US 2022/0146673 A1
(43) Pub. Date: May 12, 2022

(54) TIME OF FLIGHT DEVICE AND METHOD

(71) Applicant: Sony Semiconductor Solutions Corporation, Kanagawa (JP)

(72) Inventors: Qing Ding, Stuttgart (DE); Alper Ercan, Stuttgart (DE)

(73) Assignee: Sony Semiconductor Solutions Corporation, Kanagawa (JP)

(21) Appl. No.: 17/429,303

(22) PCT Filed: Feb. 14, 2020
(86) PCT No.: PCT/EP2020/053872

§ 371 Date: Aug. 6, 2021

(30) Foreign Application Priority Data
Feb. 15, 2019 (EP) 19157383.1

(51) Int. Cl. G01S 17/10; G01S 7/484; G01S 7/4865; G01B 11/22

(52) U.S. Cl. CPC G01S 17/10; G01B 11/22; G01S 7/4865; G01S 7/484

(57) ABSTRACT

A time-of-flight device has a light source configured to emit light pulses to a scene, a light detector configured to detect light reflected from the scene and a control, the control being configured to drive the light source to emit pulse density modulated light pulses representing a predefined light waveform, drive the light detector to detect the pulse density modulated light pulses, based on a demodulation time interval and reconstruct the predefined light waveform, based on the detected density modulated light pulses.

### TECHNICAL FIELD

The present disclosure generally pertains to a time-of-flight device and to a method for controlling a time-of-flight device.

### TECHNICAL BACKGROUND

Known time-of-flight systems typically have a light source for illuminating a region of interest and a sensor for detecting light stemming from the region of interest for determining a distance between the light source and the region of interest.

The distance can be determined, for example, based on the time-of-flight of the photons emitted by the light source and reflected in the region of interest, which, in turn, is associated with the distance.

This technology is also referred to as direct time-of-flight (dToF) and it can be based, for example, on determining a roundtrip time of the light when travelling from the light source to the region of interest and back to the sensor.

Moreover, an indirect time-of-flight device (iToF) is known, which indirectly obtains distance measurements by detecting a phase shift of the detected light, which is reflected from the scene.

Generally, for iToF it is known that cyclic errors in the phase measurements may occur during reconstruction of the phase shift, wherein such errors are typically corrected.

Although there exists a time-of-flight device and a method for controlling a time-of-flight device, it is generally desirable to provide a time-of-flight device and a method for controlling a time-of-flight device, which at least are able to reduce errors in the phase measurements.

### SUMMARY

According to a first aspect, the disclosure provides a time-of-flight device, comprising a light source configured to emit light pulses to a scene; a light detector configured to detect light reflected from the scene; and a control, the control being configured to drive the light source to emit pulse density modulated light pulses representing a predefined light waveform; drive the light detector to detect the pulse density modulated light pulses, based on a demodulation time interval; and reconstruct the predefined light waveform, based on the detected pulse density modulated light pulses.

According to a second aspect, the disclosure provides a method for controlling a time-of-flight device including a light source configured to emit light pulses to a scene and a light detector configured to detect light reflected from the scene, the method comprising driving the light source to emit pulse density modulated light pulses representing a predefined light waveform; driving the light detector to detect the pulse density modulated light pulses, based on a demodulation time interval; and reconstructing the predefined light waveform, based on the detected pulse density modulated light pulses.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates an embodiment of a ToF device;

FIG. 2 illustrates a synchronous sampling of the reflected sinusoidal intensity modulated waveform in a sinusoidal waveform scenario;

FIG. 3 illustrates a synchronous sampling of the reflected sinusoidal intensity modulated waveform in a square waveform scenario;

FIG. 4 illustrates a cyclic error in phase measurement incurred, wherein the emitted light pulse and detected light pulse represent a square waveform;

FIG. 5 illustrates an embodiment of a ToF device, wherein the emitted light pulses are pulse density modulated light pulses representing a sinusoidal waveform;

FIG. 6 illustrates an embodiment of a ToF device emitting pulse density modulated sinusoidal waveform light pulse having error detection and waveform tuning;

FIG. 7 illustrates an example of a pulse density modulation of a sinusoidal waveform;

FIG. 8 illustrates an embodiment of an improved pulse density modulated light pulse in one cycle pulse density modulated structure;

FIG. 9 illustrates an embodiment of a delay generator for pulses in different time durations; and

FIG. 10 is flowchart for an embodiment of a method for providing a ToF device.

### DETAILED DESCRIPTION OF EMBODIMENTS

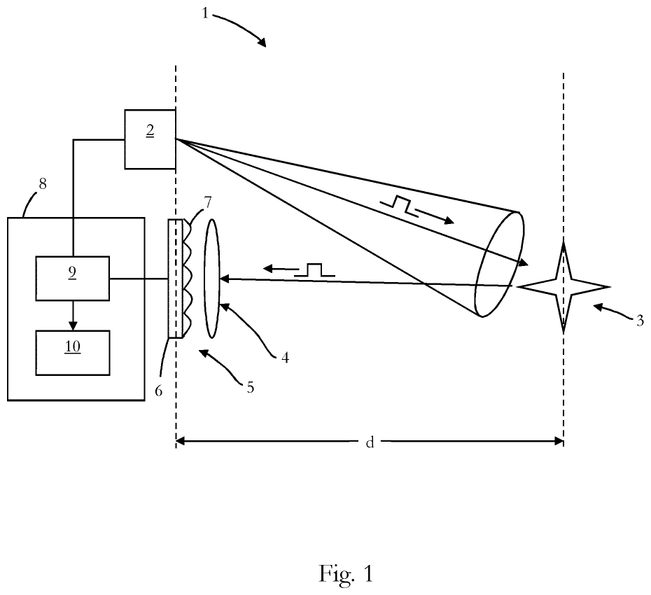

Before a detailed description of the embodiments under reference of FIG. 1 is given, general explanations are made.

As also indicated in the outset, the time-of-flight (ToF) technology may be grouped in two main techniques, namely indirect ToF (iToF) and direct ToF (dToF).

An iToF camera indirectly obtains the distance measurements by reconstructing the phase shift based on a correlation wave, e.g. between a modulation signal for driving a light source, an image sensor, or the like, and a signal obtained based on backscattered light. The correlation wave may be measured by integrating multiple cycles of detected and demodulated light signals (e.g. thousands, millions, or any other suitable number).

As indicated in the introduction, errors in the phase measurements may occur, e.g. wiggling error or cyclic error. It has been recognized, as is also explained further below, as demodulating a light pulse and calculating the phase using different equations may lead to such errors, in some embodiments the light pulses emitted to a scene represent a predefined light waveform.

Consequently, some embodiments pertain to a time-of-flight device, including a light source configured to emit light pulses to a scene, a light detector configured to detect light reflected from the scene and a control, the control being configured to drive the light source to emit pulse density modulated light pulses representing a predefined light waveform, drive the light detector to detect the pulse density modulated light pulses, based on a demodulation time interval and reconstruct the predefined light waveform, based on the detected pulse density modulated light pulses.

Some embodiments pertain also to a method for controlling a time-of-flight device, e.g. as discussed herein, including a light source configured to emit light pulses to a scene and a light detector configured to detect light reflected from the scene, wherein the method includes driving the light source to emit pulse density modulated light pulses representing a predefined light waveform, driving the light detector to detect the pulse density modulated light pulses, based on a demodulation time interval and reconstructing the predefined light waveform, based on the detected pulse density modulated light pulses.

The following description pertains to the time-of-flight device and the method for controlling the time-of-flight device.

Generally, in some of the embodiments, the time-of-flight apparatus may be based on any of known ToF technologies, including indirect ToF sensors, where the distance is indirectly measured by determining a phase shift of the emitted and received and detected light.

The light source may include LEDs (light emitting diodes) or it may be based on laser elements, such as VCSELs (vertical cavity surface emitting lasers) or the like. The light source may be configured as PW (pulsed-wave) light source, which is configured to emit light pulses to the scene (region of interest or object or the like).

The light detector may be based on any type of known sensing technology for time-of-flight systems and may be based on, for example, CMOS (complementary metal-oxide semiconductor), CCD (charge coupled device), SPAD (single photon avalanche diode), CAPD (current assisted photodiode) technology or the like. It may include multiple light detection elements (photo diodes), which may be arranged in pixels, as it is generally known.

The control may include one or more (micro)processors, field gate processors, memory, and other components which are typically implemented in an electronic control of a time-of-flight system.

The control may be configured in hardware and/or in software.

As mentioned, the control drives the light source to emit pulse density modulated light pulses representing a predefined light waveform. Hence, the emitted pulse density modulated light pulses may be such configured that they represent a sinusoidal shape, a square shape or the like, having, for example, a predefined period. Moreover, the control drives the light detector to detect the pulse density modulated light pulses, based on a demodulation time interval and to reconstruct the predefined light waveform, based on the detected pulse density modulated light pulses.

Modulating or representing waveforms by pulse density modulated pulses is generally known, and, thus, the modulation of a light waveform by pulse density modulated light pulses follows these known principles in some embodiments.

In some embodiments, the pulse density modulated light pulses representing the predefined light waveform are detected within the demodulation time interval.

In some embodiments, the period of the predefined light waveform corresponds to the demodulation time interval. The period of the predefined light waveform may be a demodulation clock period, e.g. one cycle of demodulation period T. Thereby, all pulse density modulated light pulses may be detected within one demodulation period, which corresponds to the demodulation period at which the light detector is driven and read out.

Moreover, in some embodiments the pulse density modulated light pulses representing the predefined light waveform are distributed over multiple demodulation time intervals. That is, one demodulation clock period may be divided into multiple demodulation time intervals, e.g. into N time durations.

Hence, in some embodiments the pulse density modulated light pulses representing the predefined light waveform are such distributed that for each of the multiple demodulation time intervals one light pulse is emitted. For example, only one time duration of i (i=1, 2, 3, . . . N) may be sent within one demodulation period T and the total number of sent pulses of i is Mᵢ.

Thus, in some embodiments the light source is driven to emit one light pulse of the pulse density modulated light pulses for each demodulation time interval. In one demodulation period, one light pulse may be emitted. The emitted light pulse may have a short duty cycle, which may have the same duration as the time duration of a pulse density modulated light pulse.

In some embodiments the demodulation time interval is divided into a number of demodulation time interval slots.

In some embodiments, the number of demodulation time interval slots corresponds to the number of pulse density modulated light pulses representing the predefined light waveform. The predefined light waveform represents a sinusoidal waveform if Mᵢ, i.e. the total number of type of pulse, follows the equation

$$\frac{{M}_{i}}{{\sum }_{j = 1}^{N} {M}_{j}} = \frac{1 + sin ( ( i - a ) \times \frac{2 π}{N} )}{2 π}$$

where typical value of a is 0.5 and it can be changed if necessary.

In some embodiments, the control is further configured to detect a cyclic error in a phase measurement of the detected pulse density modulated light pulses and to adjust the predefined light waveform based on the detected cyclic error. In particular, demodulating a pulse density modulated light pulse representing a sinusoidal waveform, a distance is obtained indirectly by recovering the phase component and thus the phase. The phase may be calculated using the equation

$$φ = \{ \begin{matrix}a tan ( \frac{I 0 - I 180}{I 90 - I 270} ) , if I 0 - I 180 \geq 0 and I 90 - I 270 \geq 0 \\ a tan ( \frac{I 0 - I 180}{I 90 - I 270} ) + π , if I 90 - I 270 < 0 \\ a tan ( \frac{I 0 - I 180}{I 90 - I 270} ) + 2 π , if I 0 - I 180 < 0 and I 90 - I 270 \geq 0\end{matrix}$$

where I0 is the in-phase component, I180 is the complementary component of I0, I90 is the out-phase component and I270 is the complementary component of I90.

By calculating the phase, the distance measurements may be easily calculated by using the equation

$$d = \frac{φ \times c}{4 π {f}_{mod}}$$

where c is the light speed and f_{mod} is the modulation frequency.

Moreover, demodulating a pulse density modulated light pulse representing a square waveform, the phase may be calculated using the equation

$$ϕ = \{ \begin{matrix}\frac{π}{4} - \frac{π}{4} \cdot \frac{\vert I \vert - \vert Q \vert}{\vert I \vert + \vert Q \vert} \text{:} I , Q \geq 0 \\ \frac{3 \cdot π}{4} + \frac{π}{4} . \frac{\vert I \vert - \vert Q \vert}{\vert I \vert + \vert Q \vert} \text{:} I < 0 , Q \geq 0 \\ \frac{7 \cdot π}{4} + \frac{π}{4} \cdot \frac{\vert I \vert - \vert Q \vert}{\vert I \vert + \vert Q \vert} \text{:} I \geq 0 , Q < 0 \\ \frac{5 \cdot π}{4} - \frac{π}{4} . \frac{\vert I \vert - \vert Q \vert}{\vert I \vert + \vert Q \vert} \text{:} I < 0 , Q < 0\end{matrix}$$

where I=I0−I180 and Q=I90−I270.

However, the pulse density modulated light pulses may not represent a sinusoidal waveform nor a square waveform (e.g. due to restrictions of light sources, the electronics for driving the light source, etc). Thus, calculating the phase using one of the two phase equations above may lead to a cyclic error in a phase measurement of the detected pulse density modulated light pulses. But, on the other hand, representing the light waveform with pulse density modulated light pulses at least decreases errors in the representation of the light waveform, since the waveform is reconstructed based on the multiple pulse density modulated light pulses, such that the influences of the shape of each of the light pulses on the overall light waveform is decreased.

In some embodiments, the cyclic error is minimized by iteratively adjusting the light waveform and detecting the cyclic error. In particular, a cyclic error correction may be not needed by iteratively adjusting the light waveform and detecting the cyclic error. Moreover, the calibrations on the emitted light pulse may be implement once for all, which may minimize the burden and the working frequency of the time-of-flight. Hence, in some embodiment, this cyclic error minimization is performed at an initialization or at a start of the apparatus.

Returning to FIG. 1, there is illustrated an embodiment of a time-of-flight (ToF) device 1, which can be used for depth sensing or providing a distance measurement, in particular for the technology as discussed herein. The ToF device 1 has a circuitry 8 which is configured to perform the methods as discussed herein (and which will be discussed further below) and which forms a control of the ToF device 1 (and it includes, not shown, corresponding processors, memory and storage as it is generally known to the skilled person).

The ToF device 1 has a pulsed light source 2 and it includes light emitting elements (based on laser diodes), wherein in the present embodiment, the light emitting elements are narrow band laser elements.

The light source 2 emits pulsed light, i.e. pulse density modulates light pulses, as discussed herein, to a scene 3 (region of interest or object), which reflects the light. By repeatedly emitting light to the scene 3, the scene 3 can be scanned, as it is generally known to the skilled person. The reflected light is focused by an optical stack 4 to a light detector 5.

The light detector 5 has an image sensor 6, which is implemented based on multiple SPADs (Single Photon Avalanche Diodes) formed in an array of pixels and a microlens array 7 which focuses the light reflected from the scene 3 to the image sensor 6 (to each pixel of the image sensor 6).

The light emission time and modulation information is fed to the circuitry or control 8 including a time-of-flight measurement unit 9, which also receives respective information from the image sensor 6, when the light is detected which is reflected from the scene 3. On the basis of the light waveform represented by the emitted pulse density modulated light pulses received from the light source 2 and the performed demodulation, the time-of-flight measurement unit 9 computes a phase shift of the received light pulses which have been emitted from the light source 2 and reflected by the scene 3 and on the basis thereon it computes a distance d (depth information) between the image sensor 6 and the scene 3, as also discussed above.

The depth information is fed from the time-of-flight measurement unit 9 to a 3D image reconstruction unit 10 of the circuitry 8, which reconstructs (generates) a 3D image of the scene 3 based on the depth information received from the time-of-flight measurement unit 9.

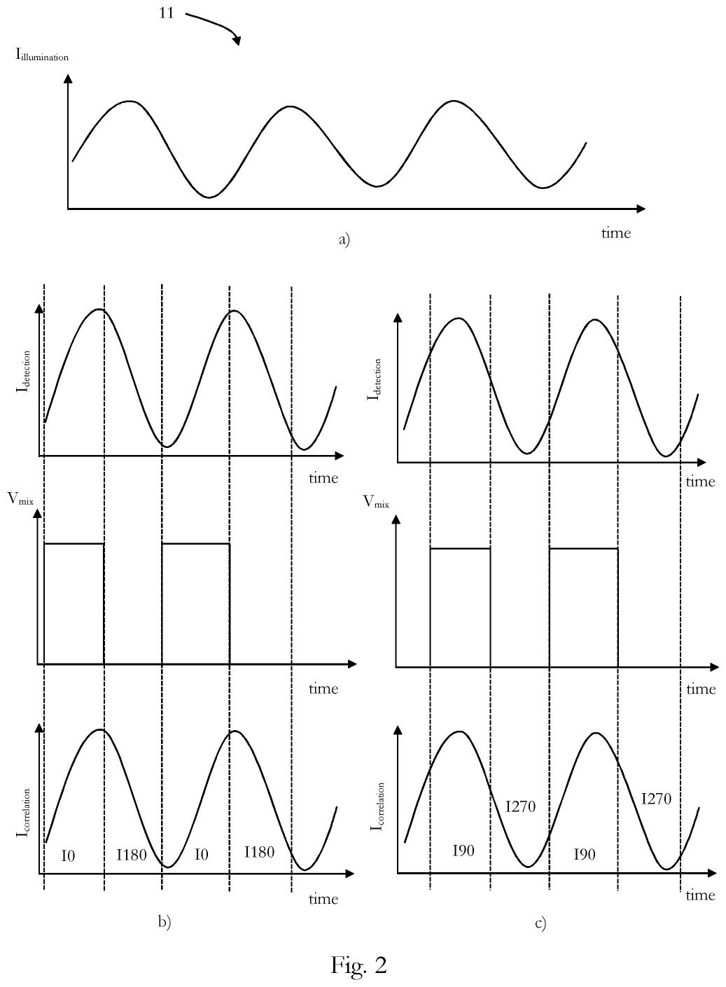

FIG. 2 illustrates a synchronous sampling of the reflected sinusoidal intensity modulated waveform in a sinusoidal waveform scenario, in order to enhance the overall understanding of the present disclosure.

FIG. 2 shows in section a) a sinusoidal waveform of a light pulse, namely the time evolution of intensity, wherein the light pulse is emitted by a ToF light source to illuminate a region of interest, e.g. a scene. The abscissa represents the time and the ordinate represents the illumination intensity.

Section b) of FIG. 2 illustrates three time evolution diagrams (upper, middle, lower) of a sinusoidal waveform signal related to the in-phase component I0 and its complementary component I180. The upper diagram illustrates the intensity of detection of a light pulse as a function of time. The abscissa represents the time and the ordinate represents the detection intensity. The middle diagram illustrates the state of the light detector (on-off state) as a function of time. The abscissa represents the time and the ordinate represents the state of the light detector. The lower diagram illustrates the intensity of correlation between the received light pulse and a demodulation clock, used as a reference clock, as a function of time. The abscissa represents the time and the ordinate represents the correlation intensity. The dashed lines divide into four sections the time-axis and represent two out of four phases of a light pulse signal, e.g. the in-phase components, namely the in-phase component I0 and the in-phase complementary component I180 of I0. The time interval that the light detector is switched on, the signal of the received light pulse is demodulated and the in-phase component I0 is acquired.

Section c) of FIG. 2 illustrates three time evolution diagrams (upper, middle, lower) of a sinusoidal waveform signal related to the out-phase component I90 and its complementary component I270. The upper diagram illustrates the intensity of detection of a light pulse as a function of time. The abscissa represents the time and the ordinate represents the illumination intensity. The middle diagram illustrates the state of the light detector (on-off state) as a function of time. The abscissa represents the time and the ordinate represents the state of the light detector. The lower diagram illustrates the intensity of correlation between the received light pulse and a demodulation clock, used as a reference clock, as a function of time. The abscissa represents the time and the ordinate represents the correlation intensity. The dashed lines divide into four sections the time-axis and represent two out of four phases of a light pulse signal, e.g. the out-phase components, namely the out-phase component I90 and the out-phase complementary component I270 of I90. The time interval that the light detector is switched on, the signal of the received light pulse is demodulated and the out-phase component I90 is acquired.

An iToF pixel sensor (e.g. ToF light detector) demodulates, e.g. millions of illumination modulation cycles reflected in the scene for sampling the correlation wave, which is based on correlation obtained by correlating emitted and detected light.

In a ToF device the light pulse emitted from the light source is consider to have a sinusoidal waveform. As it is known to the skilled person, an iToF camera indirectly obtains the depth measurements by recovering the phase of a correlation wave. The phase of the correlation wave can be calculated by using the equation (1)

$$φ = \{ \begin{matrix}a tan ( \frac{I 0 - I 180}{I 90 - I 270} ) , if I 0 - I 180 \geq 0 and I 90 - I 270 \geq 0 \\ a tan ( \frac{I 0 - I 180}{I 90 - I 270} ) + π , if I 90 - I 270 < 0 \\ a tan ( \frac{I 0 - I 180}{I 90 - I 270} ) + 2 π , if I 0 - I 180 < 0 and I 90 - I 270 \geq 0\end{matrix}$$

The distance measurement is calculated by using the equation (2)

$$d = \frac{φ \times c}{4 π {f}_{mod}}$$

where c is the light speed and f_{mod} is the modulation frequency (see also discussion above).

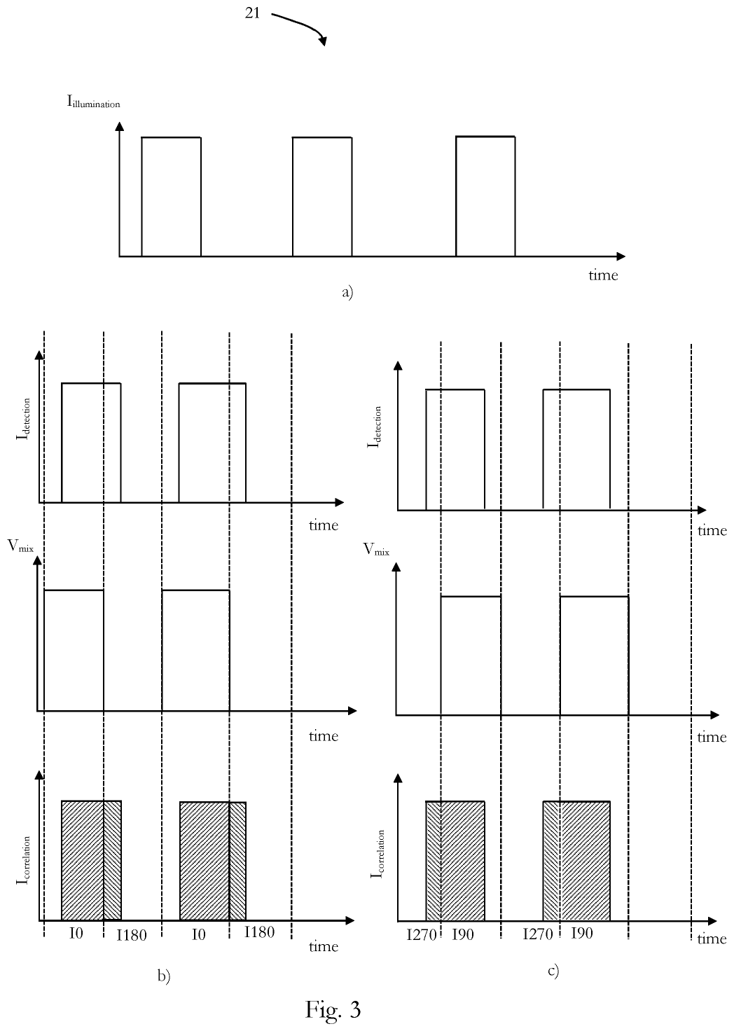

FIG. 3 illustrates a synchronous sampling of the reflected sinusoidal intensity modulated waveform in a square waveform scenario.

Section a) of FIG. 3 illustrates a square waveform of a light pulse, namely the time evolution of intensity, wherein the light pulse is emitted by a ToF light source to illuminate a region of interest, e.g. a scene. The abscissa represents the time and the ordinate represents the illumination intensity.

Section b) of FIG. 3 illustrates three time evolution diagrams (upper, middle, lower) of a square waveform signal related to the in-phase component I0 and its complementary component I180. The dashed lines divide into four sections the time-axis of the diagrams. These sections represent two out of four phases of a light pulse signal, e.g. the in-phase components, namely the in-phase component I0 and the in-phase complementary component I180 of I0. The time interval that the light detector is switched on, the signal of the received light pulse is demodulated and the in-phase component I0 is acquired.

The upper diagram illustrates the intensity of detection of a light pulse as a function of time. The abscissa represents the time and the ordinate represents the detection intensity. The middle diagram illustrates the state of the light detector (on-off state) as a function of time. The abscissa represents the time and the ordinate represents the state of the light detector. The lower diagram illustrates the intensity of correlation between the received light pulse and a demodulation clock, used as a reference clock, as a function of time. The abscissa represents the time and the ordinate represents the correlation intensity. During the time interval in which the light detector is switched on, the received light pulse signal is demodulated and the in-phase component I0 is obtained.

Section c) of FIG. 3 illustrates three time evolution diagrams (upper, middle, lower) of a sinusoidal waveform signal related to the out-phase component I90 and its complementary component I270.

The dashed lines divide into four sections the time-axis and represent two out of four phases of a light pulse signal, e.g. the out-phase components, namely the out-phase component I90 and the out-phase complementary component I270 of I90. The time interval that the light detector is switched on, the signal of the received light pulse is demodulated and the out-phase component I90 is acquired.

The upper diagram illustrates the intensity of detection of a light pulse as a function of time. The abscissa represents the time and the ordinate represents the detection intensity. The middle diagram illustrates the state of the light detector (on-off state) as a function of time. The abscissa represents the time and the ordinate represents the state of the light detector. The lower diagram illustrates the intensity of correlation between the received light pulse and a demodulation clock, used as a reference clock, as a function of time. The abscissa represents the time and the ordinate represents the correlation intensity. During the time interval in which the light detector is switched on, the received light pulse signal is demodulated and the out-phase complementary component I270 is obtained.

In FIG. 2, the light source is sinusoidal intensity modulated, where one fundamental frequency exists. However, in the practical, to ease the laser driver circuitry design complexity and improve the electrical-light efficiency, simplified electronic switching kind of laser driver is used. Thus, because of the on-off characteristic of this kind of laser drivers, square wave light pulse may be used instead of sinusoidal wave.

Having a square waveform signal the phase is calculated by using the equation (3)

$$ϕ = \{ \begin{matrix}\frac{π}{4} - \frac{π}{4} \cdot \frac{\vert I \vert - \vert Q \vert}{\vert I \vert + \vert Q \vert} \text{:} I , Q \geq 0 \\ \frac{3 \cdot π}{4} + \frac{π}{4} . \frac{\vert I \vert - \vert Q \vert}{\vert I \vert + \vert Q \vert} \text{:} I < 0 , Q \geq 0 \\ \frac{7 \cdot π}{4} + \frac{π}{4} \cdot \frac{\vert I \vert - \vert Q \vert}{\vert I \vert + \vert Q \vert} \text{:} I \geq 0 , Q < 0 \\ \frac{5 \cdot π}{4} - \frac{π}{4} . \frac{\vert I \vert - \vert Q \vert}{\vert I \vert + \vert Q \vert} \text{:} I < 0 , Q < 0\end{matrix}$$

where I=I0−I180 and Q=I90−I270.

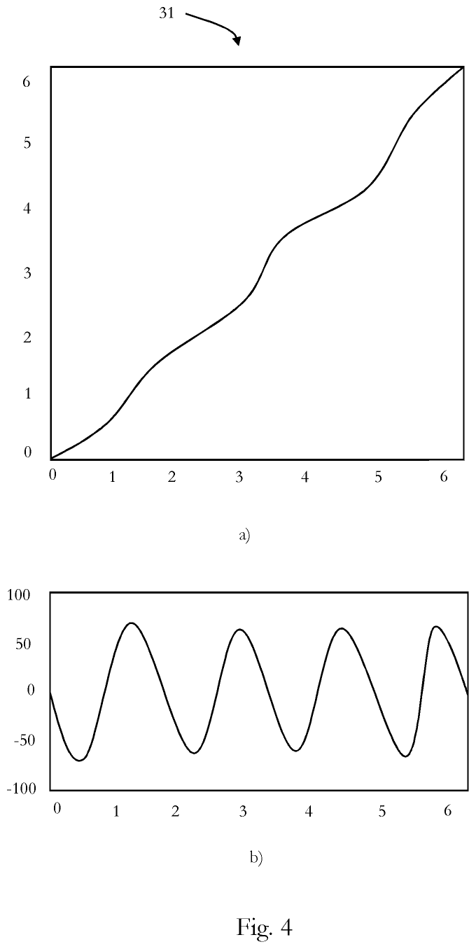

Using equation (1) to demodulate a square waveform signal, the first order harmonic of the square mixing signal will demodulate the first order harmonic of the light pulse to the fundamental frequency. This may occur to a cyclic or wiggling error, which is explained in more detail in FIG. 4. This kind error or phenomenon may occur by using the equation for a square waveform to calculate of the phase when the illumination modulation waveform is sinusoidal.

FIG. 4 illustrates a cyclic error in phase measurement incurred, wherein the emitted light pulse and detected light pulse represent a square waveform.

Section a) of FIG. 4 illustrates the measured phase in radians as a function of the input phase in radians. The abscissa represents the input phase in radians and it increases from 0 to 6. The ordinate represents the measured phase in radians and it increases from 0 to 6. Section b) of FIG. 4 illustrates the wiggling error in mill radians as a function of the input phase in radians. The abscissa represents the input phase in radians and it increases from 0 to 6. The ordinate represents the wiggling or cyclic error in mill radians and it increases from −100 to +100. As mention in FIG. 3 above, demodulating and calculating the phase of a square light pulse signal using an equation for a sinusoidal light pulse signal may result to a wiggling error or cyclic error. Accordingly, demodulating and calculating the phase of a sinusoidal light pulse signal using an equation for a square light pulse signal may result to a wiggling error or cyclic error.

Wiggling error or cyclic error may also occur in the case that the square waveform modulated light pulse is filtered to be between square waveform and sinusoidal waveform.

In some embodiments, such errors are at least reduced by representing the light waveform with pulse density modulated light pulses.

FIG. 5 illustrates an embodiment of a ToF device or system 41, wherein the emitted light pulse is a pulse density modulated sinusoidal waveform light pulse.

The light source 42 of a ToF system 41 emits light pulses to an object of interest 43, e.g. a scene, having or representing a sinusoidal light waveform, which is described in more detail in FIG. 7. The emitted light pulses are pulse density modulated (PDM) light pulses whose intensity represents a sinusoidal waveform. The light pulses reflected from the scene comprise photons, which are detected by the light detector 44 of the ToF system 41. The detected signal of the reflected light pulse is demodulated on the basis of a demodulation system clock, e.g. the demodulation frequency of the system is the same as the frequency of the sinusoidal wave. That is also referred to as asynchronous demodulation, i.e. the same frequency as the sinusoidal frequency is kept (not the PDM frequency) to detect the sinusoidal signal. By demodulating the reflected light pulses, the phase of the light wave represented by the pulse density modulated light pulses is calculated using equation (1) as long as the pulse density modulation frequency (square waveform in the PDM signal) is higher than the system bandwidth. Having a PDM modulation frequency higher than the system bandwidth may result to a minimum wiggling or cyclic error.

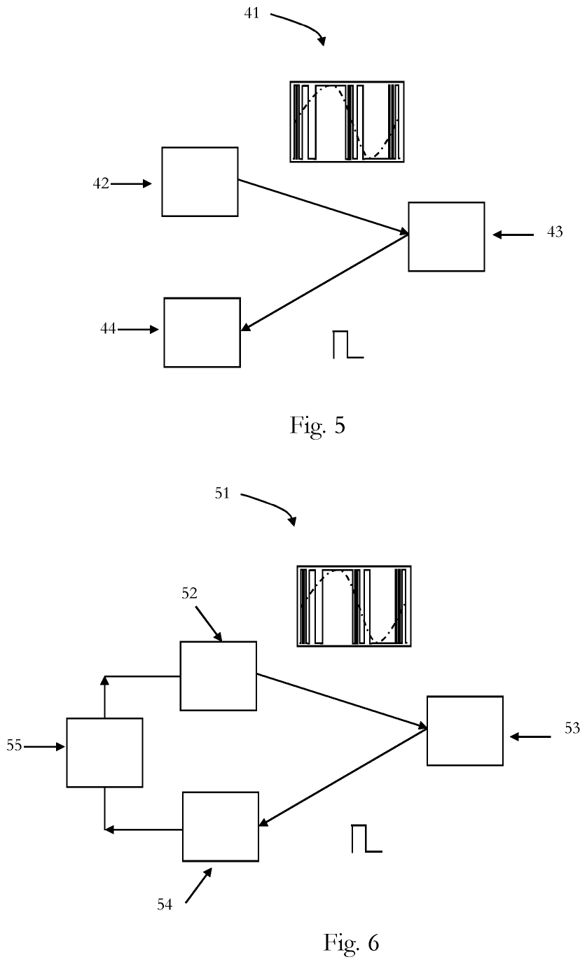

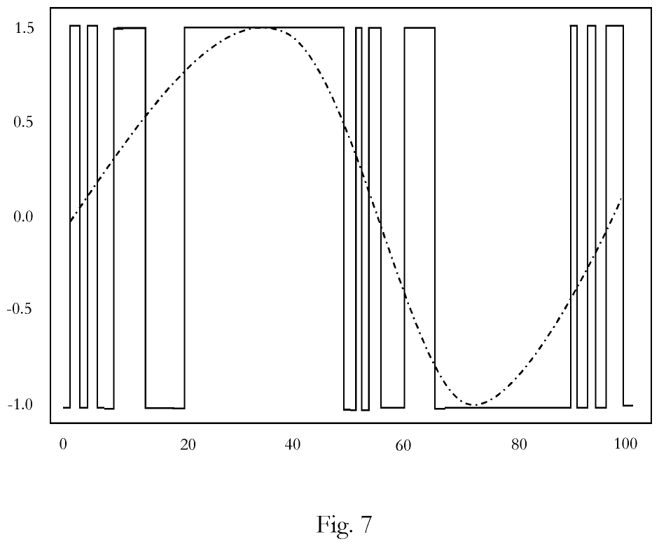

FIG. 6 illustrates an embodiment of a ToF device or system 51 emitting pulse density modulated sinusoidal waveform light pulse having error detection and waveform tuning.

The light source 52 of a ToF system 51 emits light pulses to an object of interest 53, e.g. a scene, representing a sinusoidal light waveform, which is described in more detail in FIG. 7. The emitted light pulse is a pulse density modulated (PDM) light pulse whose intensity represents a sinusoidal waveform. The reflected light pulse from the scene comprises photons, which are detected by the light detector 54 of the ToF system 51. The detected signal represented by the reflected light pulse is demodulated on the basis of a demodulation system clock, wherein, e.g., the demodulation frequency of the system is the same as the frequency of the sinusoidal wave. That is also an asynchronous demodulation, i.e. the same frequency as the sinusoidal frequency is kept (not the PDM frequency) to detect the sinusoidal signal (light waveform) represented by the multiple pulse density modulate light pulses. As described under reference of FIG. 5, having the PDM frequency higher than the system bandwidth may result to a minimum wiggling or cyclic error.

Driving the light detector 54 of the ToF system 51 to detect a cyclic error in a phase measurement of the emitted pulse density modulated light pulses and to adjust the emitted pulse density modulated light pulses to represent a pulse density modulated light waveform, includes estimating the cyclic error in the phase measurement and iteratively estimating the pulse density modulated light waveform with least cyclic error. In this embodiment, this is achieved by having inside the circuitry of the ToF system 51 an extra unit 55, e.g. an error detection and waveform tuning block, which performs the error detection and the waveform tuning as discussed herein.

The light detector 52 is controlled as to tune the shape of the light waveform represented by the emitted pulse density modulated light pulses and/or to tune the shape of the emitted light pulses to get the minimum wiggling or cyclic error. By tuning the PDM signal, the minimum wiggling or cyclic error may be achieved, due to the distortion of the illuminated light pulse or demodulation (or mixing) clocks. That is, instead of correcting the wiggling or cyclic error every time (e.g. for every measurement), the wiggling or cyclic error is estimated first (e.g. during initialization, start, production, etc.), then the waveform with least wiggling or cyclic error is calculated determined and then the emitted light pulses are tuned to this determined waveform, which is a predefined light waveform. Therefore, the wiggling or cyclic error may be corrected once for all by iteratively adjusting the waveform to be pulse density modulated and detecting the cyclic error, and then adjusting the light waveform again, etc. until the cyclic error is minimized.

FIG. 7 illustrates an example of a pulse density modulation of a sinusoidal waveform.

The abscissa represents the time (from 0 to 100) and the ordinate represents the amplitude of the signal (from −1.0 to +1.5). The continuous line represents the PDM sinusoidal waveform of a signal, i.e. the single pulse density modulated (light) pulses, and the dashed line represents the analog form of the sinusoidal waveform. In order to accurately convert a square waveform (continuous line) to a sinusoidal waveform (dashed line), pulse density modulated light pulses should be emitted for a specific time duration, e.g. a demodulation time interval. For example, to simulate a peak of a sinusoidal signal, pulse density modulated light pulses should be emitted for longer time duration than for simulating an increase or decrease of the sinusoidal signal.

The PDM signal is used for the pulse and the working frequency of the ToF system is very high, and it can be calculated, in some embodiments, using the equation

fₗₐₛₑᵣ=N*f_{demodulation} (4)

where, f_{demodulation} is the usual demodulation frequency e.g. demodulation frequency in the timeresolved pixels and N is the step number within one cycle to perform the pulse density demodulation. The demodulation frequency varies from several Mega Hz to hundreds of mega Hz.

Therefore, fₗₐₛₑᵣ may be up to several GHz or even more to ensure low wiggling or cyclic error brought in by the PDM signals, which may result to a burden for the laser design, in some embodiments.

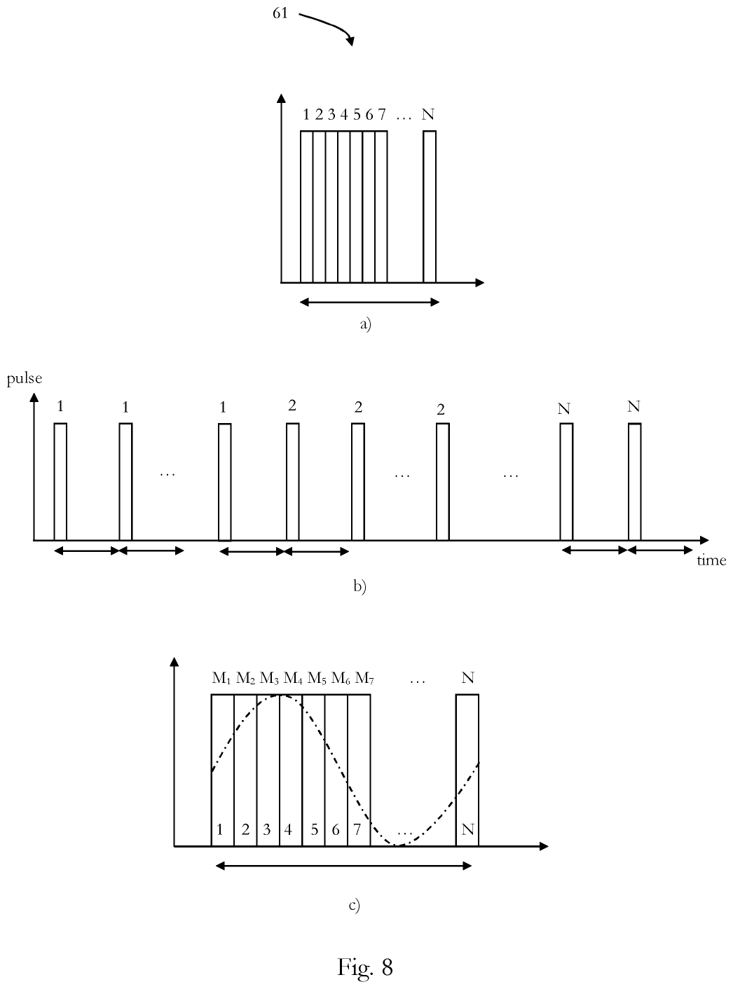

FIG. 8 illustrates an embodiment, with an pulse density modulated light pulse in a one cycle pulse density modulated structure.

Section a) of FIG. 8 illustrates one cycle of a demodulation period (double arrow) divided in to N time durations. B sending a single PDM pulse within one demodulation period, the frequency of the emission of pulse density modulated light pulses is much less compared to the embodiment, where all pulse density modulated light pulses representing one period of the light waveform are transmitted in one demodulation period, such that the light source can be drive with a less frequency. Implementing this function includes dividing one demodulation clock period T into N time durations. After that, instead of sending the PDM pulses as discussed in FIG. 5 and FIG. 6, only pulses of small time duration may be sent in one demodulation cycle as illustrated in section b) of FIG. 8. Hence, the pulse density modulated light pulses representing the predefined light waveform are distributed over multiple demodulation time intervals.

Section b) of FIG. 8 illustrates a time evolution of the emitted pulse density modulated light pulses. Every single pulse density modulated light pulse is emitted from the light source 2 within a predefined time interval, e.g. within one demodulation period T. That is, in one demodulation period T, only one pulse is emitted from the light source 2 and this pulse has short duty cycle, which is the same with the one PDM pulse time duration. After integrating for some time, many single short duty cycles PDM pulses will detected and all these pulses effectively represent the whole period of PDM signals, as illustrated in section c) of FIG. 8, such that the light waveform can be reconstructed. This sending sequence is only an example and the present invention should not limited to that example only.

Section c) of FIG. 8 illustrates all the pulses of one integration time squeezed into one effective cycle. For example, in section b) of FIG. 8, only one time duration of i (i=1, 2, 3, . . . N) is sent within one demodulation period T and the total number of sent pulses of i is FIG. 8, section c) illustrates the situation after all pules have been sent, and all the pulses are depicted as if they were into one cycle by imagination, wherein section c) of FIG. 8 shows an effective sinusoidal waveform shape, like the dashed sinusoidal wave in section c) of FIG. 8 if Mᵢ, i.e. the total number of i^{th} type of pulse, follows the equation

$$\frac{{M}_{i}}{{\sum }_{j = 1}^{N} {M}_{j}} = \frac{1 + sin ( ( i - a ) \times \frac{2 π}{N} )}{2 π} \qquad ( 5 )$$

where typical value of a is 0.5, which can be changed if necessary and/or adapted to a specific embodiment, as necessary.

The sending sequence of section b) in FIG. 8 is only one example. Any patterns or sequences may be sent in some embodiments, as long as equation (5), which defines the density of one cycle, is satisfied. Alternatively, random sequence may be sent, as long as the appearing probability of duration pulse follows the requirement of equation (5).

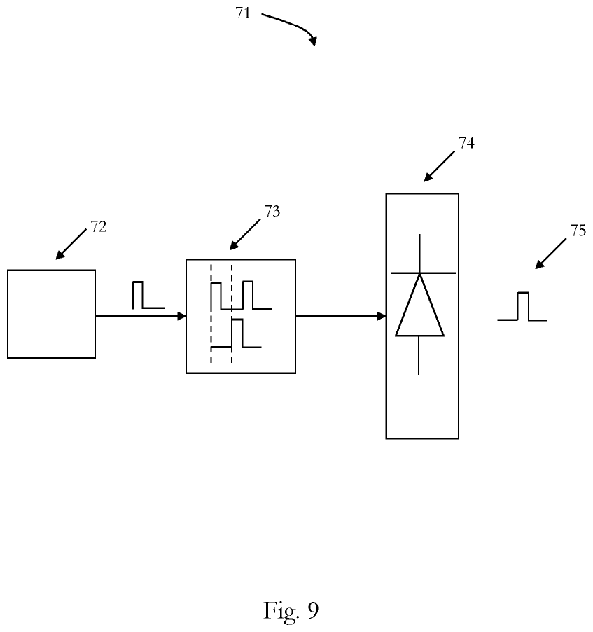

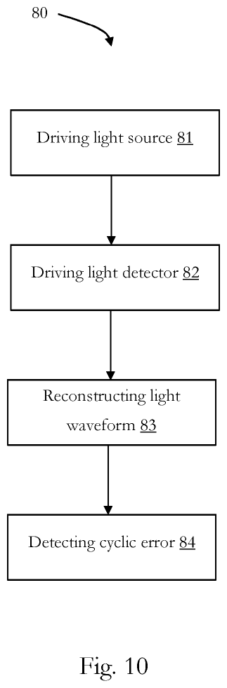

FIG. 9 illustrates an embodiment of a delay generator system 71 for emitting light pulses with different time durations, which may be implemented, for example, in the setup of FIG. 1 for implementing the embodiment of FIG. 8. The pulse generator 72 sends a pulse to a delay generator 73 for shifting the time that each light pulse will be emitted. The delay generator 73 sends a delay signal to the light source 2 to emit light pulses with different time durations and/or at different points of time.

The sequences of the emitted light pulses may also be implemented by using a delay generator as illustrated in FIG. 9. The time shift e.g. delay for every cycle may be predefined or randomly. However, this embodiment is only one example and its implementation is not limited to this.

A method 80 for controlling, e.g., the indirect ToF device 1 of FIG. 1 is discussed in the following under reference of FIG. 10 showing a flow chart of the method 80 for controlling a ToF device, such as that of FIG. 1.

At 81, the light source, such as light source 2 of FIG. 1, is driven to emit pulse density modulated light pulses representing a predefined light waveform, as discussed.

At 82, the light detector 5 is driven for detecting the pulse density modulated light pulses, based on a demodulation time interval and for reconstructing the predefined light waveform, based on the detected pulse density modulated light pulses, as discussed.

At 83, the predefined light waveform is reconstructed, based on the detected pulse density modulated light pulses, as discussed herein, wherein the pulse density modulated light pulses representing the predefined light waveform are detected within the demodulation time interval (wherein the period of the predefined light waveform corresponds to the demodulation time interval) or wherein the pulse density modulated light pulses representing the predefined light waveform are distributed over multiple demodulation time interval, as discussed above.

At 84, a cyclic error in a phase measurement of the detected pulse density modulated light pulses is detected and the predefined light waveform is adjusted based on the detected cyclic error, wherein the cyclic error is minimized by iteratively adjusting the light waveform and detecting the cyclic error, as discussed herein.

Please note that the division of the circuitry 8 into units 9 and 10 is only made for illustration purposes and that the present disclosure is not limited to any specific division of functions in specific units. For instance, the circuitry 8 could be implemented by a respective programmed processor, field programmable gate array (FPGA) and the like.

The methods as described herein, in particular method 80, are also implemented in some embodiments as a computer program causing a computer and/or a processor and/or circuitry to perform the method, when being carried out on the computer and/or processor and/or circuitry. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight device, comprising:
a light source configured to emit light pulses to a scene;
a light detector configured to detect light reflected from the scene; and
a control, the control being configured to:
drive the light source to emit pulse density modulated light pulses representing a predefined light waveform;
drive the light detector to detect the pulse density modulated light pulses, based on a demodulation time interval; and
reconstruct the predefined light waveform, based on the detected pulse density modulated light pulses.

(2) The time-of-flight device of (1), wherein the pulse density modulated light pulses representing the predefined light waveform are detected within the demodulation time interval.

(3) The time-of-flight device of anyone of (1) to (2), wherein the period of the predefined light waveform corresponds to the demodulation time interval.

(4) The time-of-flight device of anyone of (1) to (3), wherein the pulse density modulated light pulses representing the predefined light waveform are distributed over multiple demodulation time intervals.

(5) The time-of-flight device of (4), wherein the pulse density modulated light pulses representing the predefined light waveform are such distributed that for each of the multiple demodulation time intervals one light pulse is emitted.

(6) The time-of-flight device of (5), wherein the light source is driven to emit one light pulse of the pulse density modulated light pulses for each demodulation time interval.

(7) The time-of-flight device of (5), wherein the demodulation time interval is divided into a number of demodulation time interval slots.

(8) The time-of-flight device of (7), wherein the number of demodulation time interval slots corresponds to the number of pulse density modulated light pulses representing the predefined light waveform.

(9) The time-of-flight device of anyone of (1) to (8), wherein the control is further configured to detect a cyclic error in a phase measurement of the detected pulse density modulated light pulses and to adjust the predefined light waveform based on the detected cyclic error.

(10) The time-of-flight device of (9), wherein the cyclic error is minimized by iteratively adjusting the light waveform and detecting the cyclic error.

(11) A method for controlling a time-of-flight device including a light source configured to emit light pulses to a scene and a light detector configured to detect light reflected from the scene, the method comprising:
driving the light source to emit pulse density modulated light pulses representing a predefined light waveform;
driving the light detector to detect the pulse density modulated light pulses, based on a demodulation
time interval; and

reconstructing the predefined light waveform, based on the detected pulse density modulated light pulses.

(12) The method for controlling a time-of-flight device of (11), wherein the pulse density modulated light pulses representing the predefined light waveform are detected within the demodulation time interval.

(13) The method for controlling a time-of-flight device of anyone of (11) to (12), wherein the period of the predefined light waveform corresponds to the demodulation time interval.

(14) The method for controlling a time-of-flight device of anyone of (11) to (13), wherein the pulse density modulated light pulses representing the predefined light waveform are distributed over multiple demodulation time intervals.

(15) The method for controlling a time-of-flight device of (14), wherein the pulse density modulated light pulses representing the predefined light waveform are such distributed that for each of the multiple demodulation time intervals one light pulse is emitted.

(16) The method for controlling a time-of-flight device of (15), wherein the light source is driven to emit one light pulse of the pulse density modulated light pulses for each demodulation time interval.

(17) The method for controlling a time-of-flight device of (15), wherein the demodulation time interval is divided into a number of demodulation time interval slots.

(18) The method for controlling a time-of-flight device of (17), wherein the number of demodulation time interval slots corresponds to the number of pulse density modulated light pulses representing the predefined light waveform.

(19) The method for controlling a time-of-flight device of anyone of (11) to (18), further comprising detecting a cyclic error in a phase measurement of the detected pulse density modulated light pulses and adjusting the predefined light waveform based on the detected cyclic error.

(20) The method for controlling a time-of-flight device of (19), wherein the cyclic error is minimized by iteratively adjusting the light waveform and detecting the cyclic error.

1. A time-of-flight device, comprising:
a light source configured to emit light pulses to a scene;
a light detector configured to detect light reflected from the scene; and
a control, the control being configured to:
drive the light source to emit pulse density modulated light pulses representing a predefined light waveform;
drive the light detector to detect the pulse density modulated light pulses, based on a demodulation time interval; and
reconstruct the predefined light waveform, based on the detected pulse density modulated light pulses.

2. The time-of-flight device of claim 1, wherein the pulse density modulated light pulses representing the predefined light waveform are detected within the demodulation time interval.

3. The time-of-flight device of claim 2, wherein the period of the predefined light waveform corresponds to the demodulation time interval.

4. The time-of-flight device of claim 1, wherein the pulse density modulated light pulses representing the predefined light waveform are distributed over multiple demodulation time intervals.

5. The time-of-flight device of claim 4, wherein the pulse density modulated light pulses representing the predefined light waveform are such distributed that for each of the multiple demodulation time intervals one light pulse is emitted.

6. The time-of-flight device of claim 5, wherein the light source is driven to emit one light pulse of the pulse density modulated light pulses for each demodulation time interval.

7. The time-of-flight device of claim 5, wherein the demodulation time interval is divided into a number of demodulation time interval slots.

8. The time-of-flight device of claim 7, wherein the number of demodulation time interval slots corresponds to the number of pulse density modulated light pulses representing the predefined light waveform.

9. The time-of-flight device of claim 1, wherein the control is further configured to detect a cyclic error in a phase measurement of the detected pulse density modulated light pulses and to adjust the predefined light waveform based on the detected cyclic error.

10. The time-of-flight device of claim 9, wherein the cyclic error is minimized by iteratively adjusting the light waveform and detecting the cyclic error.

11. A method for controlling a time-of-flight device including a light source configured to emit light pulses to a scene and a light detector configured to detect light reflected from the scene, the method comprising:
driving the light source to emit pulse density modulated light pulses representing a predefined light waveform;
driving the light detector to detect the pulse density modulated light pulses, based on a demodulation time interval; and
reconstructing the predefined light waveform, based on the detected pulse density modulated light pulses.

12. The method for controlling a time-of-flight device of claim 11, wherein the pulse density modulated light pulses representing the predefined light waveform are detected within the demodulation time interval.

13. The method for controlling a time-of-flight device of claim 12, wherein the period of the predefined light waveform corresponds to the demodulation time interval.

14. The method for controlling a time-of-flight device of claim 11, wherein the pulse density modulated light pulses representing the predefined light waveform are distributed over multiple demodulation time intervals.

15. The method for controlling a time-of-flight device of claim 14, wherein the pulse density modulated light pulses representing the predefined light waveform are such distributed that for each of the multiple demodulation time intervals one light pulse is emitted.

16. The method for controlling a time-of-flight device of claim 15, wherein the light source is driven to emit one light pulse of the pulse density modulated light pulses for each demodulation time interval.

17. The method for controlling a time-of-flight device of claim 15, wherein the demodulation time interval is divided into a number of demodulation time interval slots.

18. The method for controlling a time-of-flight device of claim 17, wherein the number of demodulation time interval slots corresponds to the number of pulse density modulated light pulses representing the predefined light waveform.

19. The method for controlling a time-of-flight device of claim 11, further comprising detecting a cyclic error in a phase measurement of the detected pulse density modulated light pulses and adjusting the predefined light waveform based on the detected cyclic error.

20. The method for controlling a time-of-flight device of claim 19, wherein the cyclic error is minimized by iteratively adjusting the light waveform and detecting the cyclic error.
